(19) United States
(12) Patent Application Publication
(10) Pub. No.: US 2005/0273798 A1
(43) Pub. Date: Dec. 8, 2005

(54) Optical disc drive

(75) Inventor: Tzu-Nan Chen, Taipei (TW)

Correspondence Address: BACON & THOMAS, PLLC, 625 SLATERS LANE, FOURTH FLOOR, ALEXANDRIA, VA, 22314, US

(73) Assignee: LITE-ON IT CORPORATION, Taipei (TW)

(21) Appl. No.: 11/138,404

(22) Filed: May 27, 2005

(30) Foreign Application Priority Data
Jun. 8, 2004 (TW) 93116486

(51) Int. Cl. G11B 7/08; G11B 7/085; G11B 7/09; G11B 23/03

(52) U.S. Cl. 720/690

(57) ABSTRACT

An optical disc drive, comprising a base frame, a traverse and a positioning device is provided. The base frame has a bottom plate, while the traverse has a first side and a second side corresponding to each other, wherein the first side is connected to the base frame. The traverse uses the first side as a pivot point and swings towards the bottom plate, causing the second side to move between a first position and a second position, wherein the second side of the traverse is nearest to the bottom plate when positioned at the second position. The positioning device guides the second side of the traverse to the second position, at which the second side of the traverse is positioned.

This application claims the benefit of Taiwan application Serial No. 93116486, filed Jun. 8, 2004, the subject matter of which is incorporated herein by reference.

### BACKGROUND OF THE INVENTION

1. Field of the Invention

The invention relates in general to an optical disc drive, and more particularly to an optical disc drive enabling the traverse to move upwardly and downwardly firmly.

2. Description of the Related Art

With the current trend of increasing demand for the storage of digital data, conventional floppy disc is unable to meet the current trend, optical disc has become the mainstream storage media, and optical disc drive has become one of the essential equipment of a computer. Generally speaking, each desktop computer has a tray-type optical disc drive.

In a tray-type optical disc drive of prior art, the four ends of the traverse have dampers disposed thereon, wherein the dampers are respectively fixed on the housing and the frame via elements such as screws for instance. Besides, the housing normally has an up-down plate disposed thereon, wherein the up-down plate has at least a guide slot, which is coupled to the corresponding protrusion disposed on the frame.

When the tray is released from the optical disc drive, firstly, the tray will drive the up-down plate to move to one side. Next, the protrusion disposed on the frame will match with the guide slot disposed on the up-down plate, the frame will be guided by the guide slot to shift downwardly and cause one side of the traverse to shift downwardly as well. Lastly, the turntable of the rotation spindle will be detached from the optical disc to release the disc.

Since the other side of the traverse is fixed on the housing via a damper, in the course of downward shift, the traverse is like using the damper fixed on the housing as a pivot point and rotates. However, the traverse has a fixed length and when rotating downwardly, one side of the traverse connected to the frame will move away from the guide slot, the protrusion disposed on the frame is likely to be detached from the guide slot if the protrusion is not long enough. Consequently, the optical disc drive is unable to function normally.

### SUMMARY OF THE INVENTION

It is therefore an object of the invention to provide an optical disc drive, the traverse of the optical disc drive will not be detached from the guide slot, which guides the movement of the traverse, in the course of upward/downward movement

It is therefore another object of the invention to provide an optical disc drive comprising a base frame, a traverse and a positioning device is provided. The base frame has a bottom plate, while the traverse has a first side and a second side corresponding to each other, wherein the first side is connected to the base frame. The traverse uses the first side as a pivot point and swings towards the bottom plate, causing the second side to move between a first position and a second position, wherein the second side of the traverse is nearest to the bottom plate when positioned at the second position. The positioning device guides the second side of the traverse to the second position, at which the second side of the traverse is positioned

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 is a decomposition diagram of an optical disc drive according to a first embodiment of the invention;

FIG. 2A is a sectional diagram when the second side of a traverse of an optical disc drive according to a first embodiment of the invention is at a first position;

FIG. 2B is a sectional diagram when the second side of a traverse of an optical disc drive according to a first embodiment of the invention is at a second position;

FIG. 2C is a three-dimensional diagram of another angle of is an optical disc drive according to a first embodiment of the invention;

FIG. 3 is a decomposition diagram of an optical disc drive according to a second embodiment of the invention;

FIG. 4 is a decomposition diagram of an optical disc drive according to a third embodiment of the invention; and

FIG. 5 is a decomposition diagram of an optical disc drive according to a fourth embodiment of the invention.

### DETAILED DESCRIPTION OF THE INVENTION

The optical disc drive according to the invention uses a positioning device to guide the path of movement of the traverse or the supporting element, lest the traverse or supporting element might have poor coupling with the base frame when an optical disc is released from the optical disc drive. The invention is exemplified by four embodiment disclosed below.

### First Embodiment

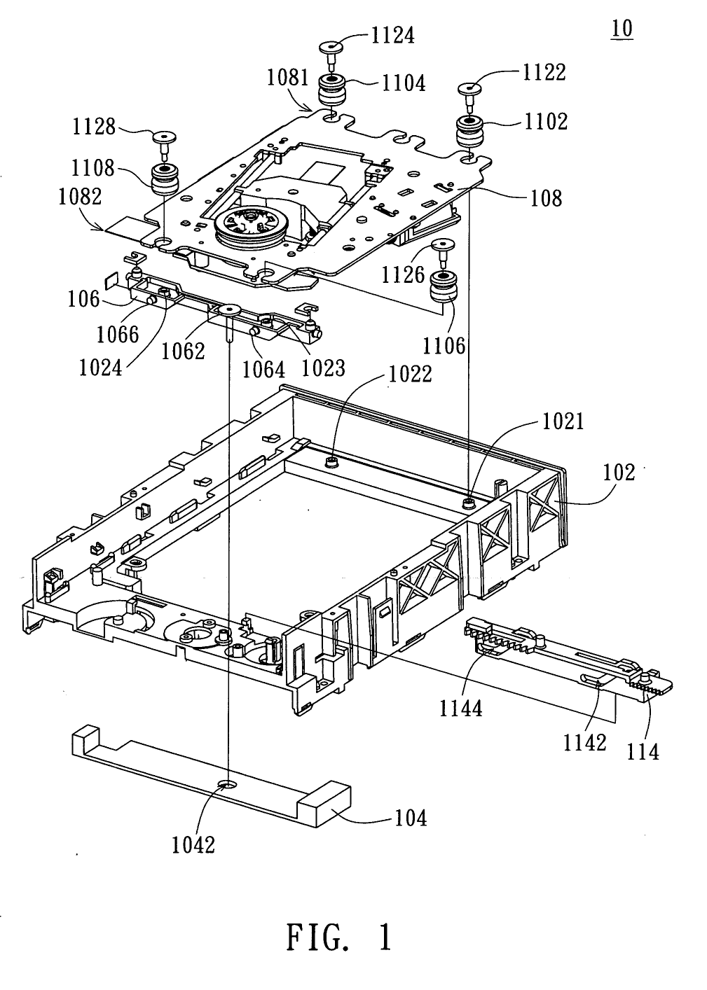

Referring to FIG. 1, a decomposition diagram of an optical disc drive according to a first embodiment of the invention is shown. The base frame 102 of optical disc drive 10 has positioning holes 1021, 1022 for positioning disposed thereon. The two ends of the first side 1081 of the traverse 108 respectively have dampers 1102 and 1104 disposed thereon. The two dampers respectively use positioning pieces 1122 and 1124 to be positioned at positioning holes 1021 and 1022. Correspondingly, the two ends of the second side 1082 of the traverse 108 respectively have dampers 1106 and 1108, which respectively use positioning pieces 1126 and 1128 to be positioned at positioning holes 1023 and 1024 of a supporting element 106, wherein the supporting element 106 can be a frame for instance.

In addition to the positioning holes 1023 and 1024, the supporting element 106 further has protrusions 1064 and 1066. An up-down plate 114, which is horizontal slideably disposed on the base frame 102 and corresponds to one side of the positioning holes 1021 and 1021, further has guide slots 1142 and 1144 disposed thereon. The protrusion 1064 is correspondingly inserted into the guide slot 1142, while the protrusion 1066 is correspondingly inserted into the guide slot 1144.

Furthermore, the supporting element 106 has a positioning protrusion 1062 disposed thereon, wherein the positioning protrusion 1062 can be a positioning rod extended from the supporting element 106 or an independent metallic element. The bottom plate 104, which is disposed on the base frame 102, has a positioning indention 1042 corresponding to the positioning protrusion 1062. Preferably, the bottom plate 104 and the base frame 102 both have a formed-in-one-block structure, and the positioning indention 1042 is an aperture as shown in FIG. 1.

When up-down plate 114 moves horizontally, the protrusions 1064 and 1066 are respectively guided by the guide slots 1142 and 1144 to drive the supporting element 106 to move upwardly and downwardly, causing the second side 1082 of the traverse 108 to move towards the bottom plate 104 and swing back and forth between the first position and the second position using the dampers 1102 and 1104 disposed on the first side 1081as a pivot point.

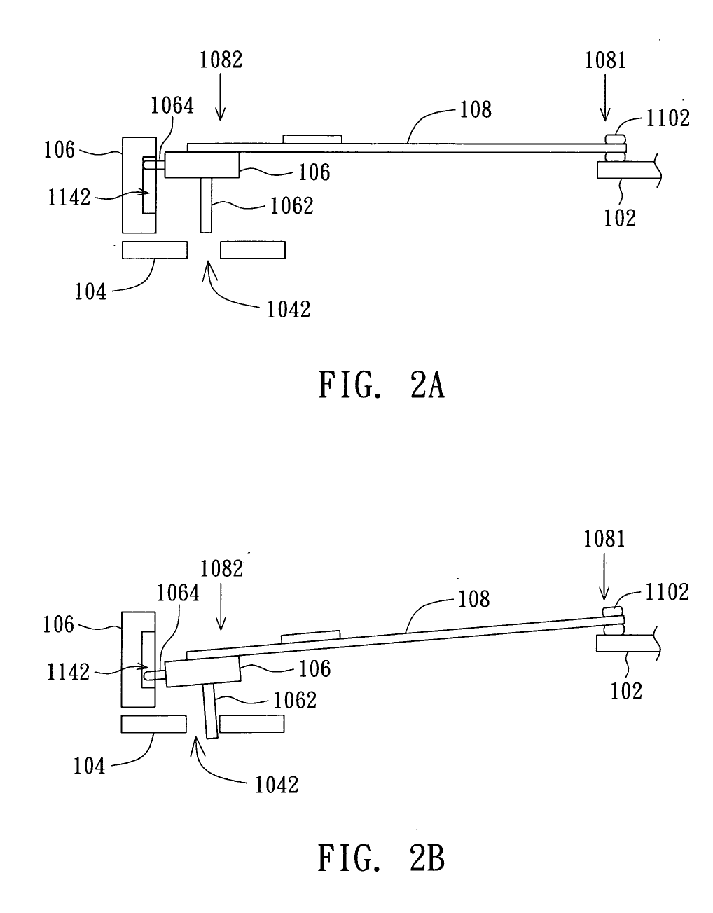

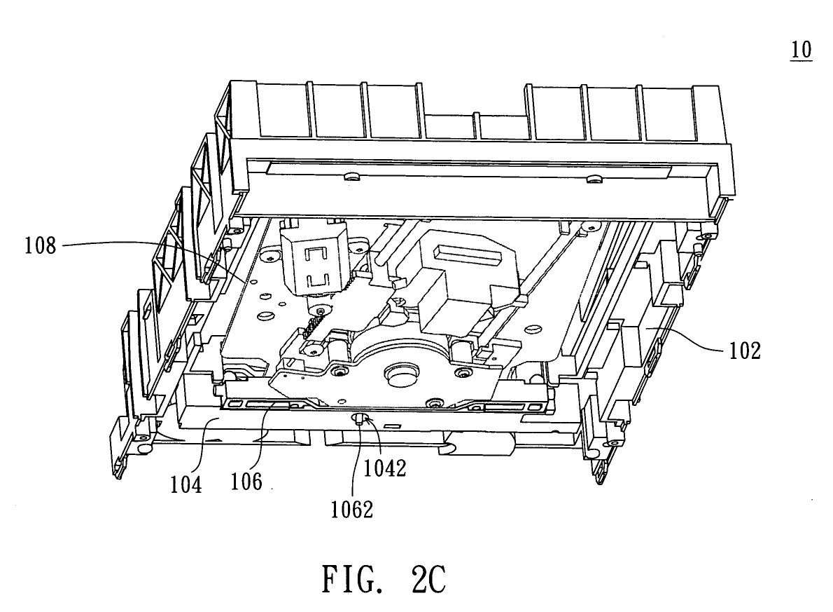

Referring to FIG. 2A, a sectional diagram when the second side of a traverse of an optical disc drive according to a first embodiment of the invention is at a first position is shown. When the second side 1082 of the traverse 108 is positioned at the first position, the supporting element 106 and the traverse 108 are at a horizontal state. Referring to FIG. 2B, a sectional diagram when the second side of a traverse of an optical disc drive according to a first embodiment of the invention is at a second position is shown. When the up-down plate 114 move horizontally, the guide slot 1142 guides the protrusion 1064 to move towards the bottom plate 104 and brings the supporting element 106 and the traverse 108 to move in the same direction together. When the supporting element 106 is moving, the positioning protrusion 1062 can extend and penetrate the positioning indention 1042, an aperture for instance. Through the matching between the positioning indention 1042 and the positioning protrusion 1062, the supporting element 106 and the traverse 108 move along the direction guided by the positioning protrusion 1062. At last, the second side 1082 of the traverse 108 is positioned at the second position.

Referring to FIG. 2C, a three-dimensional diagram of another angle of is an optical disc drive according to a first embodiment of the invention is shown. When the second side 1082 of the traverse 108 is positioned at the second position, the horizontal shift of the supporting element 106 is effectively restricted within the aperture of the positioning indention 1042. When the diameter of the aperture of the positioning indention 1042 is just wide enough for the positioning protrusion 1062 to pass through, the horizontal shift of the supporting element 106 can even be eliminated. Thus, as long as the diameter of the aperture of the positioning indention 1042 remains within a pre-determined diameter, the protrusions 1064 and 1066 disposed on the supporting element 106 will remain received by the guide slot 1142, preventing the supporting element 106 from being detached from the guide slots 1142 and 1144 due to an oversized horizontal shift.

The dampers 1102 and 1104 are made of soft materials. Therefore when the second side 1082 of the traverse 108 moves towards the bottom plate 104 and swings back and forth between the first position and the second position, the dampers 1102 and 1104 are still used as a pivot point.

### Second Embodiment

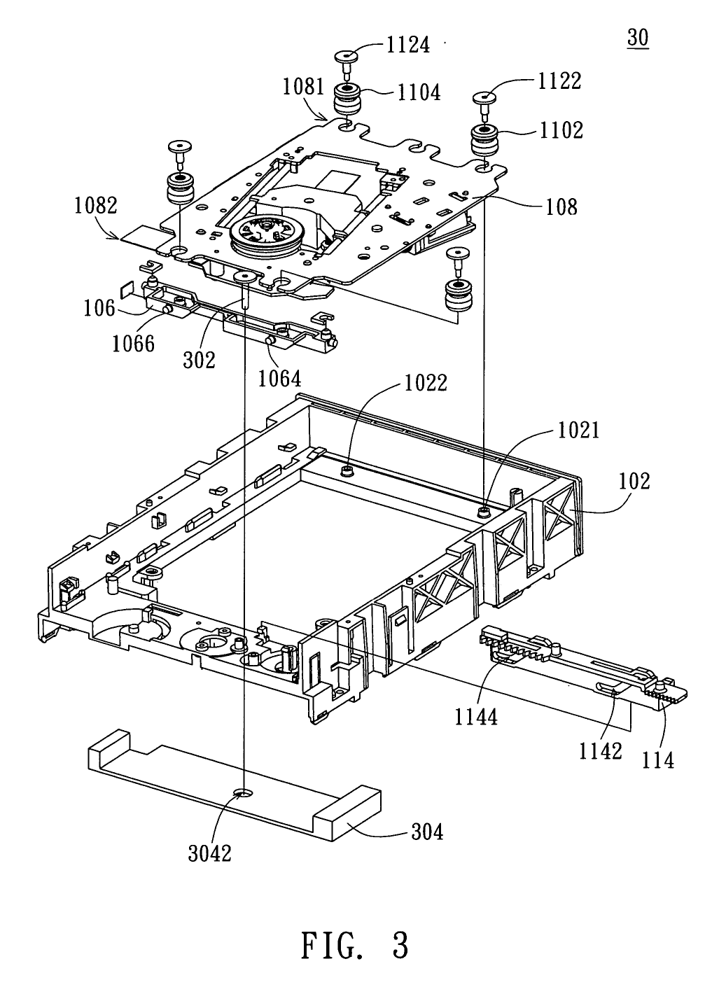

Referring to FIG. 3, a decomposition diagram of an optical disc drive according to a second embodiment of the invention is shown. The optical disc drive 30 in the second embodiment differs with the optical disc drive 10 in the first embodiment only in the disposition of the positioning device. As for other elements which do not change, the labeling remains unchanged.

The positioning device of the optical disc drive 30 comprises a positioning protrusions 302 and a positioning indention 3042. The positioning protrusion 302 is disposed on the second side 1082 of the traverse 108 and extends towards the bottom of the base frame 102. The bottom plate 304 has the positioning indention 3042 disposed thereon, wherein the positioning indention 3042, which corresponds to the positioning protrusion 302, is preferably an aperture. Since the traverse 108 is fixed on the supporting element 106, restricting the horizontal shift of the traverse 108 is equivalent to restricting the horizontal shift of the supporting element 106. With the matching between the positioning indention 3042 and the positioning protrusion 302, the second side 1082 of the traverse 108 swings back and forth towards the bottom plate 304, the horizontal shift of the traverse 108 is effectively restricted within the pre-determined aperture, causing the horizontal shift of the supporting element 106 to be restricted at the same time. Thus, the protrusions 1064 and 1066 disposed on the supporting element 106 still remain being received in the guide slots 1142 and will not be detached from the guide slots 1142 and 1144. So, the second side 1082 of the traverse 108 can move upwardly and downwardly firmly.

### Third Embodiment

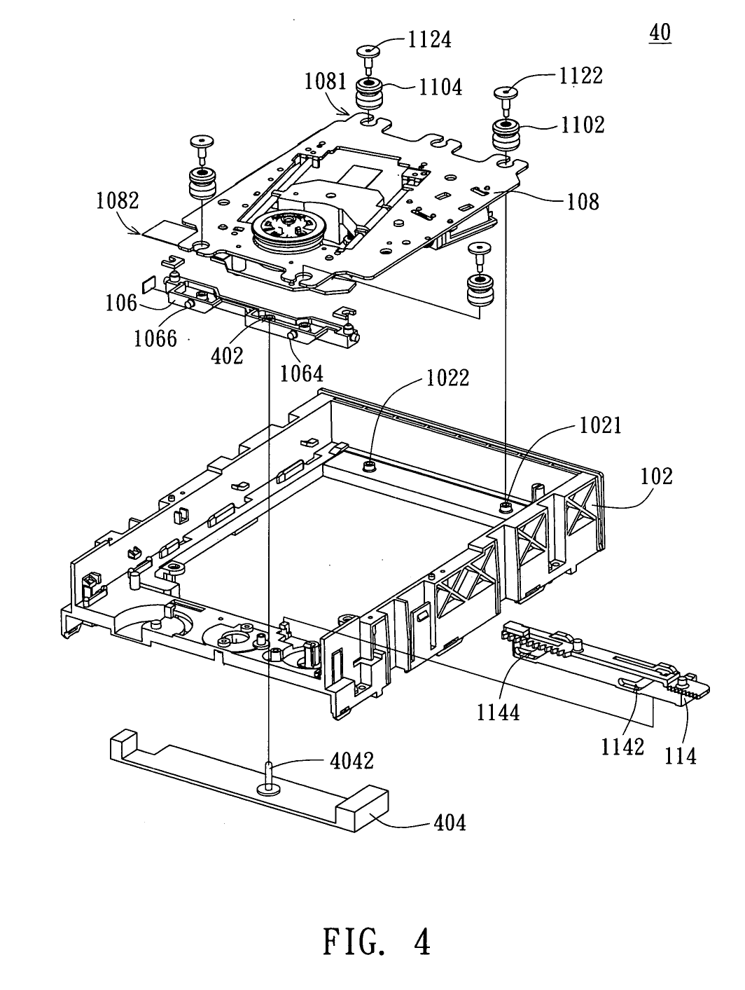

Referring to FIG. 4, a decomposition diagram of an optical disc drive according to a third embodiment of the invention is shown. The optical disc drive 40 in the third embodiment differs with the optical disc drive 10 in the first embodiment only in the disposition of the positioning protrusion and the corresponding positioning indention thereof. As for other elements which do not change, the labeling remains unchanged.

The positioning device of the optical disc drive 40 comprises positioning protrusions 4042 and a positioning indention 402. The positioning protrusion 4042 is disposed on the bottom plate 404. The supporting element 106 has the positioning indention 402 disposed thereon, wherein the positioning indention 402, which corresponds to the positioning protrusion 4042, is preferably an aperture. With the matching between the positioning indention 402 and the positioning protrusion 4042, the horizontal shift of the supporting element 106 created when the supporting element 106 moves towards the bottom plate 404 will be effectively restricted within the diameter of the aperture of the positioning indention 402. The supporting element 106 will not create an oversized horizontal shift which will separate the protrusions 1064 and 1066 from the guide slots 1142 and 1144, thus achieving the same effect with what the optical disc drive 10 does in the first embodiment.

### Fourth Embodiment

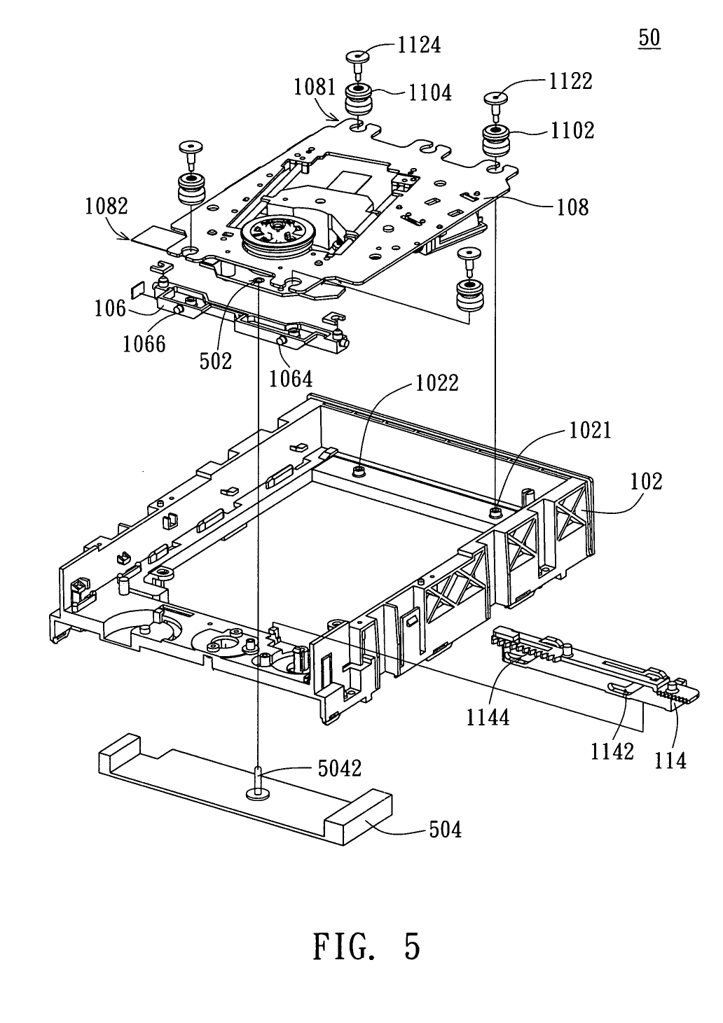

Referring to FIG. 5, a decomposition diagram of an optical disc drive according to a fourth embodiment of the invention is shown. The optical disc drive 50 in the fourth embodiment differs with the optical disc drive 40 in the third embodiment only in the disposition of the positioning device. As for other elements which do not change, the labeling remains unchanged.

The positioning device of optical disc drive 50 comprises a positioning protrusion 5042 and a positioning indention 502. The positioning protrusion 5042 is disposed on the bottom plate 504. The traverse 108 has the positioning indention 502 disposed thereon, wherein the positioning indention 502 corresponds to the positioning protrusion 5042. The positioning indention 502 is disposed on the traverse 108 instead of the supporting element 106. However, the traverse 108 is fastened onto the supporting element 106, so guiding the shift path of the traverse 108 is equivalent to guiding the shift path of the supporting element 106. In other words, as long as the horizontal movement of the traverse 108 is restricted to a pre-determined diameter of aperture of the positioning indention, the protrusions 1064 and 1066 disposed on supporting element 106 will not be detached from the guide slots 1142 and 1144, achieving the same effect according to the spirit of the invention.

The above embodiments of the invention effectively, which prevents the traverse from being detached from the up-down plate during swinging, largely enhances the reliability of the optical disc drive and is a very practical invention.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

1. An optical disc drive comprising:
a base frame having a bottom plate;
a traverse having a first side and a second side corresponding to each other, the first side is connected to the base frame, the traverse uses the first side as a pivot point and swings back and forth towards the bottom plate, causing the second side to move between a first position and a second position, wherein the second side is nearest to the bottom plate when positioned at the second position; and
a positioning device for guiding the second side of the traverse to the second position at which the second side of the traverse is positioned.

2. The optical disc drive according to claim 1, wherein the positioning device comprises a positioning protrusion and a positioning indention, wherein the positioning protrusion, extending towards the bottom plate, is disposed on the second side of the traverse, while the positioning indention, corresponding to the positioning protrusion, is disposed on the bottom plate.

3. The optical disc drive according to claim 2, wherein the positioning protrusion is a positioning rod, while the positioning indention is an aperture.

4. The optical disc drive according to claim 1, wherein the optical disc drive further comprises a supporting element connected to the second side of the traverse for bearing the traverse, the positioning device comprises a positioning protrusion and a positioning indention, wherein the positioning protrusion, extending towards the bottom plate, is disposed on the supporting element, while the positioning indention, corresponding to the positioning protrusion, is disposed on the bottom plate.

5. The optical disc drive according to claim 4, wherein the positioning protrusion is a positioning rod, while the positioning indention is an aperture.

6. The optical disc drive according to claim 1, wherein the positioning device comprises a positioning protrusion and a positioning indention, wherein the positioning protrusion is disposed on the bottom plate, while the positioning indention is disposed on the traverse, the positioning protrusion corresponds to the positioning indention and extends towards the traverse.

7. The optical disc drive according to claim 6, wherein the positioning protrusion is a positioning rod, while the positioning indention is an aperture.

8. The optical disc drive according to claim 1, wherein the optical disc drive further comprises a supporting element connected to the second side of the traverse for bearing the traverse, the positioning device comprises a positioning protrusion and a positioning indention, wherein the positioning protrusion, extending towards the supporting element, is disposed on the bottom plate, while the positioning indention, corresponding to the positioning protrusion, is disposed on the supporting element.

9. The optical disc drive according to claim 8, wherein the positioning protrusion is a positioning rod, while the positioning indention is an aperture.

10. The optical disc drive according to claim 1, wherein both the bottom plate and the base frame have a formed-in-one-block structure.

11. An optical disc drive, comprising:
a base frame having a bottom plate;
a traverse having a first side and a second side corresponding to each other, wherein the first side is connected to the base frame;
a supporting element, which has at least a protrusion and is connected to the second side of the traverse for bearing the traverse;
an up-down plate, which is slideably disposed on the base frame and has at least a guide slot into which the protrusion is correspondingly inserted, wherein when the up-down plate slides, the protrusion is guided by the guide slot to drive the supporting element, causing the supporting element to swing back and forth towards the bottom plate using the first side as a pivot point, and causing the second side to move between a first position and a second position, wherein the second side is nearest to the bottom plate when positioned at the second position; and
a positioning device for guiding the second side of the traverse to the second position at which the second side of the traverse is positioned.

12. The optical disc drive according to claim 11, wherein the positioning device comprises a positioning protrusion and a positioning indention, wherein the positioning protrusion, facing the bottom plate, is disposed on either of the traverse and the supporting element, the positioning indention, corresponding to the positioning protrusion, is disposed on the bottom plate.

13. The optical disc drive according to claim 12, wherein the positioning protrusion is a positioning rod, while the positioning indention is an aperture.

14. The optical disc drive according to claim 11, wherein the positioning device comprises a positioning protrusion and a positioning indention, wherein either of the traverse and the supporting element has the positioning indention, the positioning protrusion, facing and corresponding to the positioning indention, is disposed on the bottom plate.

15. The optical disc drive according to claim 14, wherein the positioning protrusion is a positioning rod, while the positioning indention is an aperture.

16. The optical disc drive according to claim 11, wherein both the bottom plate and the base frame have a formed-in-one-block structure.
